(19) United States
(12) Patent Application Publication
(10) Pub. No.: US 2011/0167361 A1
(43) Pub. Date: Jul. 7, 2011

(54) WEB BROWSING SYSTEM, CONTROL METHOD FOR WEB BROWSING SYSTEM AND INTERVENING SERVER

(75) Inventor: Kentaro WATANABE, Tokyo (JP)

(73) Assignee: FUJIFILM Corporation, Tokyo (JP)

(21) Appl. No.: 12/968,089

(22) Filed: Dec. 14, 2010

(30) Foreign Application Priority Data
Jan. 5, 2010 (JP) 2010-000672

(51) Int. Cl. G06F 3/00

(52) U.S. Cl. 715/760

(57) ABSTRACT

When a user ID received from a mobile phone is authenticated, the intervening server retrieves those operation histories which are stored in association with the same user ID as received one, and sorts the retrieved operation histories in the order from most often executed operation sequence to least. The sorted operation histories are converted to image data for displaying a list of operation histories in the sorted order. The intervening server also produces data for displaying user interface elements on the operation history list, and transmits it along with the image data of the operation history list to the mobile phone. The operation history list is displayed with the user interface elements superimposed thereon. Clicking on one of the user interface elements transmits a corresponding history ID to the intervening server. Thereby the intervening server executes the same operation sequence as recorded in the operation history of the received history ID.

### BACKGROUND OF THE INVENTION

1. Field of the Invention

The present invention relates to a web browsing system, a control method for the web browsing system, and an intervening server for the system.

2. Description of the Related Art

Thin client system has been known as a current web browsing system. In the thin client system, an intervening server captures a web page from a web server in response to operational information transmitted from a client terminal, such as a mobile or cellular phone. The intervening server converts the captured web page to image data that makes a web image corresponding to the web page viewable on the client terminal, e.g. on an LCD of a mobile phone, and transmits the web image data to the client terminal.

Thus, an end user of the client terminal can browse the web page as an image. Since the client terminal is not required to convert web pages to image data, the volume of data to process in the client terminal is significantly reduced.

A web page typically has user interface (UI) elements, which may include a text box or boxes, check boxes, buttons and links, enabling the user to enter operational information. The function of the user interface of the web page, that may be called the page UI, will be lost with the conversion from the web page to the image data, disabling the user to enter operational information on the web image as it is. Therefore, the thin client system is configured to superimpose specific user interface elements on the web image on the client terminal, functioning like the page UI on the web page. The user can enter operational information through the superimposed user interface, that may be called the image UI, by operating operation tools or members of the client terminal.

On the other hand, with advanced miniaturization of mobile phones, their operation members such as an Enter button and menu keys are so downsized that it is uneasy for the users to enter complicated operational information. There is a demand for such mobile phones that allow the users to enter information with simplified operation.

For example, a prior art disclosed in JPA2002-149310, provides an operation suggesting server, an operation suggesting terminal and an operation suggesting method, which are configured to store a history of operations on a mobile terminal, transmit the stored operation history to an intervening server to calculate a shortcut operation that is equivalent to but simplifies a sequence of operations indicated by the operation history received on the intervening server, and send the shortcut operation sequence back to the mobile terminal, enabling the user to control the mobile terminal with the shortcut operation to accomplish the same task as it could be achieved by the equivalent more complicated operations.

U.S. Pat. No. 6,751,508 (corresponding to JPA2002-082702) discloses a control information output device and an information system, which store information about dependency of applications to be executed in a user terminal. The dependency information shows whether each application depends upon user factors such as time and place, or as media factors such as genre and maker of the application. With reference to the dependency information, those factors upon which an application newly selected on the user terminal are searched for, to select those applications which depend upon the same factors as the newly selected application as related applications. Then, on the basis of the factors the selected applications depend upon, the necessity for the selected related applications is estimated, to automatically execute any of the related applications if needed so much. Thus, entry of operational information is simplified.

A mobile terminal as disclosed in JPA2008-293243 records operations done on the terminal, to display a recorded operation history, which also includes menu transition, as a list on its LCD at the start of the next operation. The user can choose an appropriate menu from the list, so the selected menu screen is displayed on the LCD, allowing the user to enter operational information with ease. In comparison with the above mentioned prior arts, the third prior art may further simplify the user operation because the user is merely required to choose one operation or menu from among the displayed operation history.

Generally, what kind of operations the user make on a mobile phone varies more or less with the communicative conditions such as web access time and location, i.e. when and where the mobile phone access or logs into a web server. For instance, a businessman tends to use his mobile phone to access those web servers for searching for business-related information during the day, while he tends to use the mobile phone to access those web servers for searching for leisure-related information at night.

According to the third prior art, operations that have been made on a mobile terminal to provide accesses to web servers are recorded and displayed time-sequentially, i.e. in the order of occurrence. Therefore, it is likely that those web accesses made last night to search for leisure-related information are displayed first in the operation history, even while the user is seeking to select an access to a web server for searching for business-related information from among the operation history in the morning. In that case, it takes time and effort to reach the desired selection.

### SUMMARY OF THE INVENTION

In view of the foregoing, an object of the present invention is to provide a web browsing system, a method of controlling the web browsing system, and an intervening server for the system.

To achieve the above and other objects, a web browsing system of the present invention comprises a mobile terminal and an intervening server connectable to each other over a network, wherein the mobile terminal comprises an input device operated to input operational information, and a display device that displays images including various information.

The intervening server comprises an authenticating device that authenticates the user of the mobile terminal on the basis of terminal information about the mobile terminal when the terminal information is received from the mobile terminal; a web page capturing device that captures a web page from a web server in accordance with operational information from the mobile terminal when the mobile terminal is authenticated by the authenticating device; a converter that converts the web page to image data for displaying a web image corresponding to the web page on the display device of the mobile terminal; and a device that produces data for displaying user interface elements on the web image, the user interface elements having the same function as user interface elements provided on the web page.

The intervening server also comprises a history storage device that stores operation histories each recording a sequence of operational information received from an authenticated mobile terminal in association with terminal information about the authenticated mobile terminal; a retrieving device that retrieves, each time the mobile terminal is authenticated, those operation histories which are stored in association with the terminal information of the authenticated mobile terminal from the history storage device; and a sorting device that sorts the retrieved operation histories in the order determined based on communicative conditions between the mobile terminal and the intervening server.

The intervening server further comprises a second converter that converts the retrieved operation histories to image data for displaying an operation history list of the retrieved operation histories in the order determined by the sorting device; and a device that produces data for displaying user interface elements on the operation history list in correspondence with the respective operation histories, the user interface element having a function to enter the same sequence of operational information as recorded in the corresponding operation history.

The data for displaying user interface elements on the web image is transmitted along with the data for displaying the web image from the intervening server to the authenticated mobile terminal, to allow the display device to display the web image with the user interface elements superimposed thereon, enabling entering operational information through the user interface on the web image.

The data for displaying user interface elements on the operation history list is transmitted along with the data for displaying the operation history list from the intervening server to the authenticated mobile terminal, to allow the display device to display the operation history list with the user interface elements superimposed thereon, enabling entering the same sequence of operational information as recorded in the corresponding operation history through the user interface element.

Thus, the mobile terminal can display the operation histories stored in association with the terminal information of this mobile terminal in the order determined based on the communicative conditions between the mobile terminal and the intervening server.

The communicative conditions between the mobile terminal and the intervening server may include the frequency of receiving the same operational information from the same mobile terminal, the location where the mobile terminal transmits the operational information to the intervening server, and/or the time when the operational information is transmitted from the mobile terminal to the intervening server.

One of the user interface elements displayed on the operation history list may be selectable by operating the input device, to transmit a sequence of operational information corresponding to the selected user interface from the mobile terminal to the intervening server.

Preferably, the retrieving device retrieves from the history storage device those operation histories which are associated with both the same terminal information and operation information as received from the authenticated mobile terminal.

Multiple mobile terminals are connectable to the intervening server, and the history storage device may store the operation histories in groups sorted according to the associated terminal information.

The intervening server may sort the multiple mobile terminals into groups according to their terminal information, and the retrieving device may also retrieves from the history storage device those operation histories which are associated with the terminal information of those mobile terminals which belong to the same group as the authenticated mobile terminal.

These configurations will facilitate retrieving relevant operation histories from the history storage device and also assist the user to find desired operation histories more easily.

Another aspect of the present invention provides a control method for a web browsing system comprising a mobile and an intervening server connectable over a network.

In the control method of the present invention, the user of the mobile terminal is authenticated by the intervening server on the basis of terminal information about the mobile terminal when the intervening server receives the terminal information from the mobile terminal. When the mobile terminal is authenticated, the intervening server is controlled to capture a web page from a web server in accordance with operational information from the mobile terminal, and convert the web page to image data for displaying a web image corresponding to the web page on the display device of the mobile terminal.

The intervening server is also controlled to produce data for displaying user interface elements on the web image, the user interface elements having the same function as user interface elements provided on the web page, and transmit the data for displaying user interface elements on the web image along with the data for displaying the web image to the authenticated mobile terminal, to allow the display device of the mobile terminal to display the web image with the user interface elements superimposed thereon on, enabling entering operational information through the user interface on the web image.

The intervening server is further controlled to store operation histories, each operation history recording a sequence of operational information received from an authenticated mobile terminal in association with terminal information about the authenticated mobile terminal. Each time the mobile terminal is authenticated, those operation histories which are stored in association with the terminal information of the authenticated mobile terminal are retrieved and sorted in the order determined based on communicative conditions between the mobile terminal and the intervening server.

The retrieved operation histories are converted to image data for displaying an operation history list of the retrieved operation histories in the order determined by the sorting step. Data for displaying user interface elements on the operation history list in correspondence with the respective operation histories is also produced in the intervening server, the user interface element having a function to enter the same sequence of operational information as recorded in the corresponding operation history.

The intervening server is controlled to transmit the data for displaying user interface elements on the operation history list along with the data for displaying the operation history list to the authenticated mobile terminal, to allow the display device to display the operation history list with the user interface elements superimposed thereon, enabling entering the same sequence of operational information as recorded in the corresponding operation history through the user interface element.

Note that the retrieving device may retrieve only one operation history from the history storage device. Even in that case, the second converter converts the retrieved operation history to the image data for displaying the operation history list, and the data for displaying a user interface on the operation history list is produced and transmitted along with the image data of the operation history list to the mobile phone.

The above-mentioned mobile terminals may include mobile phones, note or laptop computers, PDA (Personal Digital Assistant) and any other mobile communication terminals.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a diagram illustrating a web browsing system in accordance with the principle of the present invention;

FIG. 2 is a block diagram illustrating a circuitry of a mobile phone;

FIG. 3 is an explanatory diagram illustrating a main web page of a web server;

FIG. 4 is an explanatory diagram illustrating data for displaying user interface elements;

FIG. 5 is a front view of a mobile phone displaying an image of the main web page and pseudo user interface elements;

FIG. 6 is an explanatory diagram illustrating a news web page;

FIG. 7 is an explanatory diagram illustrating data for displaying user interface elements;

FIG. 8 is a front view of the mobile phone displaying an image of the news web page and pseudo user interface elements;

FIG. 9 is a front view of the mobile phone displaying an image of a business news page;

FIG. 10 is an explanatory diagram illustrating operation history data;

FIG. 11 is a front view of the mobile phone displaying an operation history list and pseudo user interface elements;

FIG. 12 is a flowchart illustrating a procedure for browsing web pages;

FIG. 13 is a block diagram illustrating a circuitry of a mobile phone in an embodiment, wherein operation histories are sorted with reference to access location data;

FIG. 14 is an explanatory diagram illustrating operation history data;

FIG. 15 is a front view of a mobile phone displaying an image of a web page for train schedules and pseudo user interface elements;

FIG. 16 is a front view of the mobile phone displaying an image of a web page for a train schedule;

FIG. 17 is a front view of the mobile phone displaying an operation history list and pseudo user interface elements in the embodiment of FIG. 13;

FIG. 18 is a flowchart illustrating a procedure for browsing web pages according the embodiment of FIG. 13;

FIG. 19 is an explanatory diagram illustrating operation history data in another embodiment, wherein operation histories are sorted with reference to access time data;

FIG. 20 is a front view of a mobile phone displaying an image of a web page for timecard and pseudo user interface elements;

FIG. 21 is a front view of the mobile phone displaying an image of a web page notifying of the completion of data entry;

FIG. 22 is a front view of a mobile phone displaying an operation history list and pseudo user interface elements in the embodiment shown in FIG. 19;

FIG. 23 is a flowchart illustrating a procedure for browsing web pages according to the embodiment of FIG. 19; and

FIG. 24 is a front view of a mobile phone of another embodiment, wherein a button to return to a main web page is displayed with an operation history list.

### DETAILED DESCRIPTION OF THE PREFERRED EMBODIMENTS

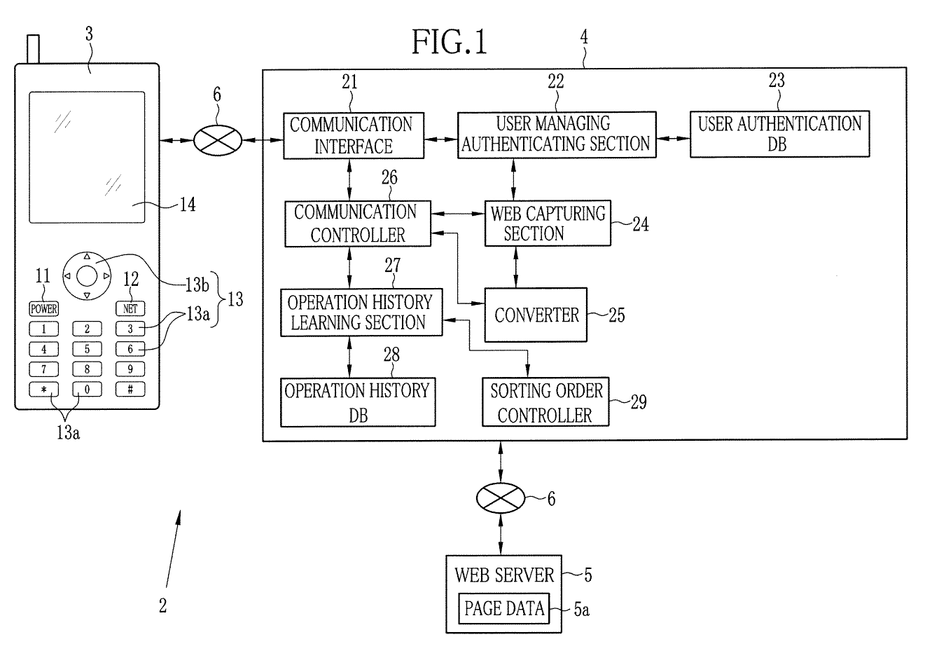

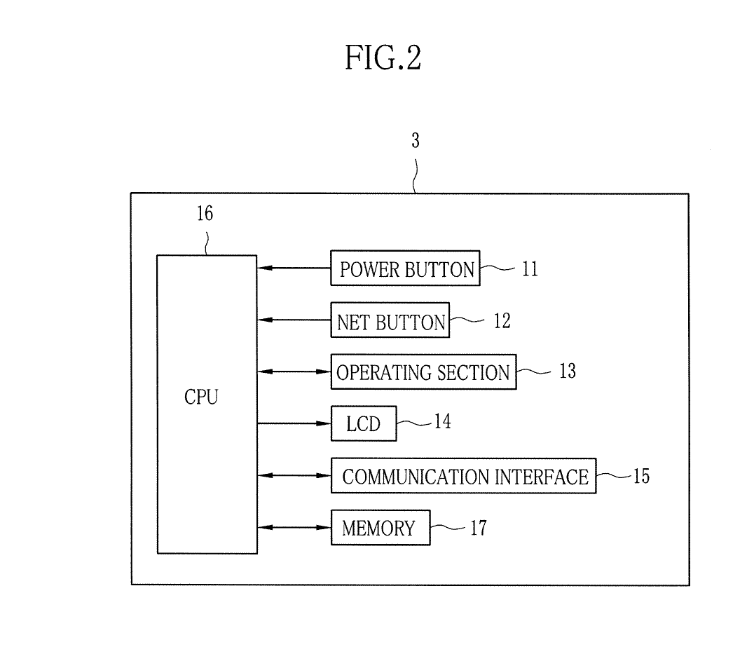

Referring to FIGS. 1 and 2, a web browsing system 2 according to an embodiment of the present invention includes a mobile terminal such as a mobile phone 3, an intervening server 4 and a web server 5. The mobile phone 3 is connectable to the intervening server 4 over an appropriate network, e.g. the Internet 6, and the intervening server 4 is connectable to the web server 5 over the Internet 6. Note that the web browsing system of the invention may include multiple mobile terminals, intervening servers and web servers.

The web server 5 stores page data 5a constituting web pages.

The page data 5a includes HTML data and other data associated with the HTML data, such as CSS (Cascading Style Sheets) data and image data. The page data 5a is designed for web browsers of personal computers. Alternatively, the page data 5a may be described in any markup language other than HTML, and CSS data and image data may be stored in other servers.

The mobile phone 3 may choose between talk mode and internet mode. In the talk mode, the mobile phone 3 can receive and send a call from and to another mobile phone or a fixed-line phone. In the Internet mode, the mobile phone 3 is connected to the intervening server 4.

The mobile phone 3 has an operating section 13 and an LCD 14. The operating section 13 includes a power button 11, a net button 12 for switching to the internet mode, multiple input keys 13a, and a menu key 13b for various setups, selections and decisions. The mobile phone 3 also includes a communication interface 15 for the connection to the intervening server 4 through the Internet 6, a CPU 16 for comprehensive control of respective elements of the mobile phone 3, and a memory 17.

The memory 17 stores phone numbers which may be read from the memory 17 by operating the menu key 13b in the talk mode. Based on a phone number read out from the memory 17 or entered by operating the input keys 13a, the mobile phone 3 may wirelessly communicate with a base station of a mobile phone company. The user can talk with another person on the other phone over a microphone and a speaker, which are not shown but incorporated in the mobile phone 3.

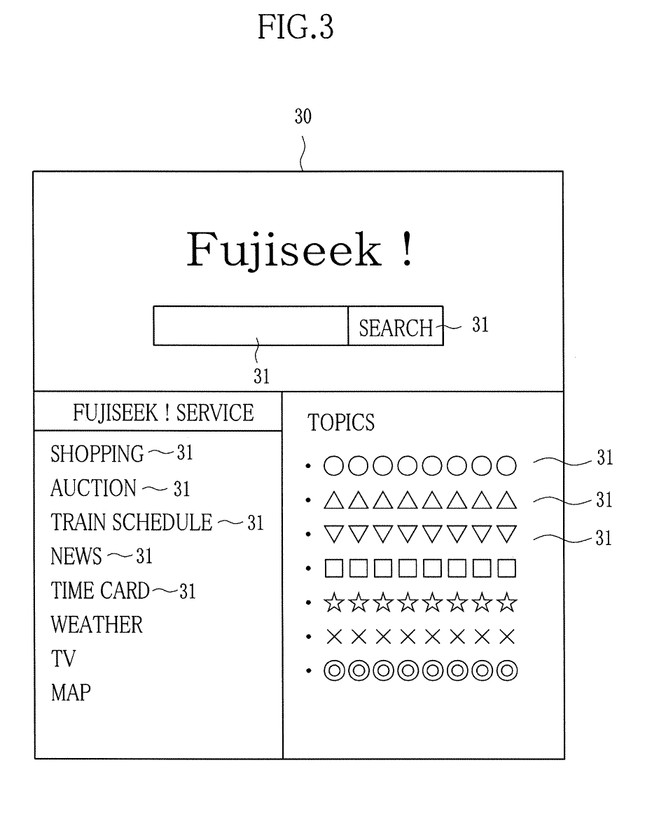

The memory 17 also stores a user ID as terminal information that identifies the individual mobile phone 3. When the mobile phone 3 is set to the internet mode by operating the net button 12, the CPU 16 activates a viewer to transmit an URL address and the user ID to the intervening server 4, requesting an access to an addressed web page. In the present example, the URL address is directed to a front or main web page of the web server 5, as shown for example in FIG. 3. Other mobile terminals connectable to the intervening server 4 also have their own user IDs, and may operate in the same way as the mobile phone 3.

The intervening server 4 includes a communication interface 21 for connecting the intervening server 4 to the mobile phone 3 through the Internet 6, a user managing authenticating section 22 for managing and authenticating the users or mobile terminals with reference to the user IDs, and a user authentication database (DB) 23 storing a number of user IDs for authentication.

The intervening server 4 also includes a web capturing section 24, a converter 25 and a communication controller 26. The web capturing section 24 is an application for capturing a desired web page from the web server 5 in response to operational information from the mobile phone 3. The converter 25 converts the captured web page to image data for displaying a web image corresponding to the web page on the mobile phone 3. The communication controller 26 transmits the image data to the mobile phone 3. It is to be noted that capturing a web page here means rendering the web page according to an analysis or interpretation of the page data 5a obtained from the web server 5, i.e. HTML data or other markup language data.

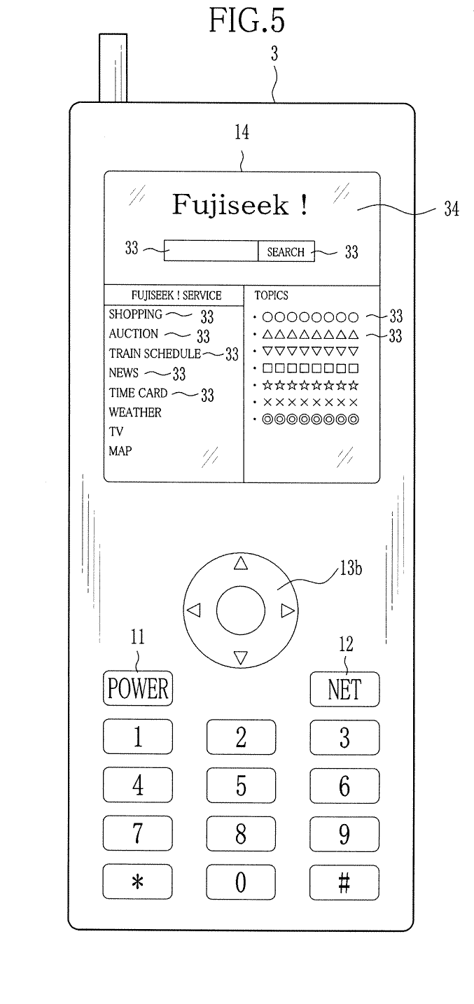

When the intervening server 4 receives a user ID, the user managing authenticating section 22 determines whether the received user ID coincides with one of the authenticated user IDs stored in the user authentication database 23. If the user ID coincides with a authenticated one, the user or the mobile phone 3 is authenticated, and the intervening server 4 accesses the web server 5 to capture the main web page 30 of the web server 5 at the converter 25 according to the URL address from the mobile phone 3. Then, The converter 25 converts the main web page 30 to image data for displaying a web image 34 (see FIG. 5) corresponding to the main web page 30 on the LCD 14 of the mobile phone 3. The communication controller 26 transmits the image data of the web image 34 to the mobile phone 3.

As shown for example in FIG. 3, the main web page 30 contains various user interface (UI) elements 31, such as a text box, check boxes, buttons and links.

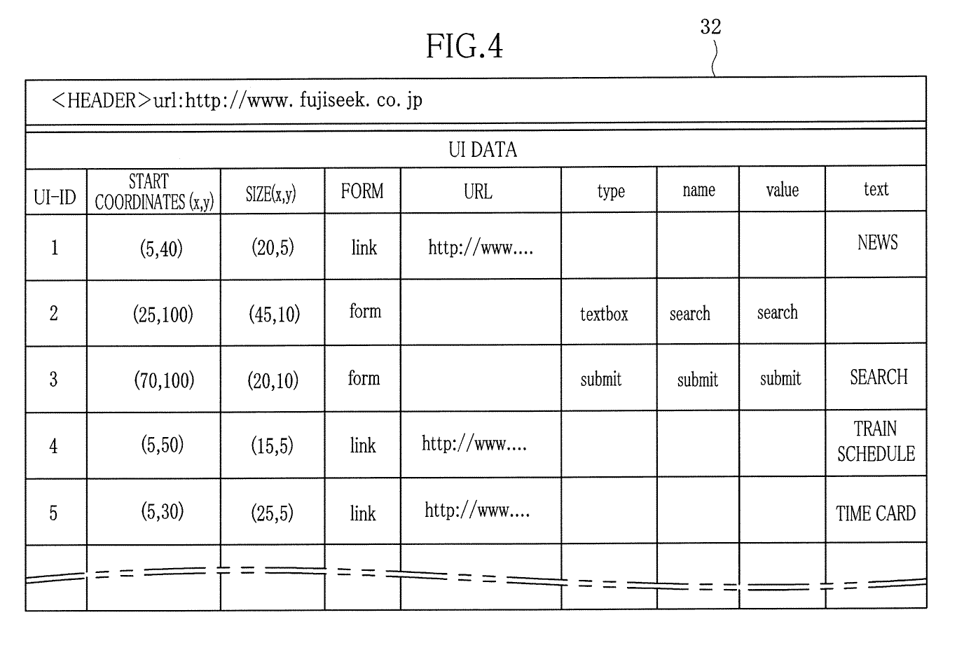

FIG. 4 shows user interface (UI) data 32 for displaying the respective UI elements 31 on the main web page 30. The UI data 32 represents information about the individual UI element 31, including an ID of the user interface element (UI-ID), coordinate values of the start position to display the UI element 31 on the main web page 30, the display size of the UI element 31, the form of the UI element 31, a linked URL address, and attribute values in HTML tags of the UI element 31. For example, the start position on the main web page 30 may be an upper left corner point of a rectangular outline of each display area for the UI element 31. Attribute values in HTML tags may include type, name, value, text, and other attributes of the UI element 31.

The intervening server 4 produces data for displaying pseudo UI elements 33 on the web image 34, corresponding to the respective UI elements 31 of the main web page 30. As being displayed on the web image 34, the pseudo UI elements 33 provide the same functions as the UI elements 31 on the main web page 30. The intervening server 4 produces the data for displaying the pseudo UI elements 33 on the basis of the UI data of the UI elements 31. The communication controller 26 transmits the data for displaying the pseudo UI elements 33 along with the data for displaying the web image 34 to the mobile phone 3. The data for displaying the pseudo UI elements 33 includes the position and size of each of the pseudo UI elements 33 on the web image 34, which may be determined by correlating the coordinate system of the web image 34 with that of the main web page 30.

On the basis of the data for displaying the web image 34 and the data for displaying the pseudo UI elements 33, the CPU 16 of the mobile phone 3 controls the LCD 14 to display the web image 34 and the pseudo UI elements 33 on the web image 34, as shown in FIG. 5, which may also be referred to as image UI elements 33 here. The pseudo UI elements 33 are superimposed on the web image 34 in the same layout as the corresponding UI elements 31 on the main web page 30. For example, based on the data for displaying a pseudo UI element 33 entitled “news”, which corresponds to an UI element 31 entitled “news” on the main web page 30, the pseudo UI element “news” is located on the web image 34 at a position corresponding to the position of the UI element “news” on the main web page 30. The data for displaying the pseudo UI element 33 is individually tagged with the same UI-ID as the corresponding UI element 31.

Although the function of the UI elements 31 on the main web page 30 is lost with the conversion from the main web page 30 to the web image 34, i.e. from HTML data to image data, the pseudo UI elements 33 superimposed on the web image 34 provide the same function as the UI elements 31, allowing the user to enter and transmit operational information through the pseudo UI elements 33 to the intervening server 4.

As the web image 34 and the pseudo UI elements 33 are displayed on the LCD 14, a not-shown cursor initially indicates the uppermost UI element 33. When the cursor is put on any desirable UI element 33 by operating the operating section 13, the selected UI element 33 is highlighted. The user may enter an instruction at the selected UI element 33, and an UI operation signal representative of the entered instruction and the UI-ID of the selected UI element 33 is transmitted from the mobile phone 3 to the intervening server 4. In response to the UI operation signal, the intervening server 4 executes a process corresponding to the instruction from the mobile phone 3, e.g. captures a web page of the linked web site.

In case where the pseudo UI elements 33 is of checkbox type or pulldown menu type, the mobile phone 3 controls the display of the pseudo UI elements 33 according to operations applied to the pseudo UI elements 33. Operations applied to the pseudo UI elements 33 may include clicks, text-entry, mouse-over and other operations commonly done on web pages. The pseudo UI elements 33 selected by the cursor may be highlighted by color-marking, stamping, underlining, or framing.

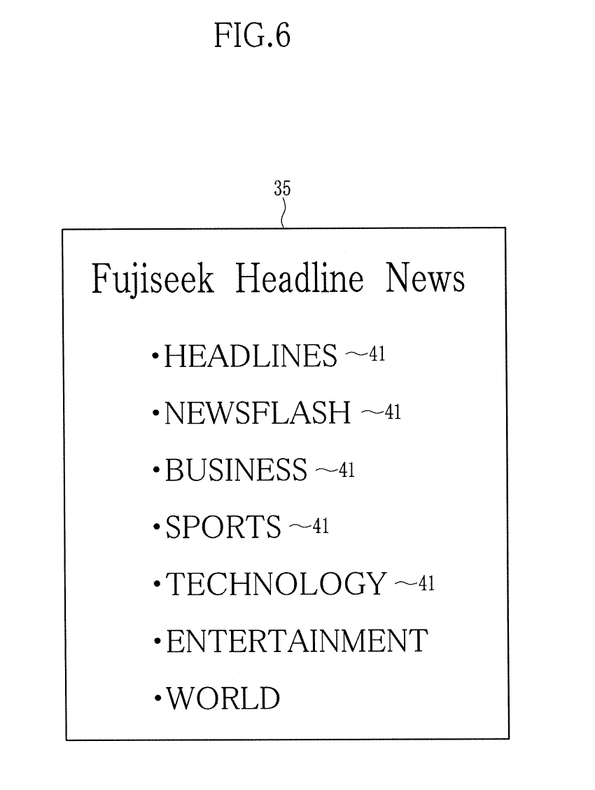

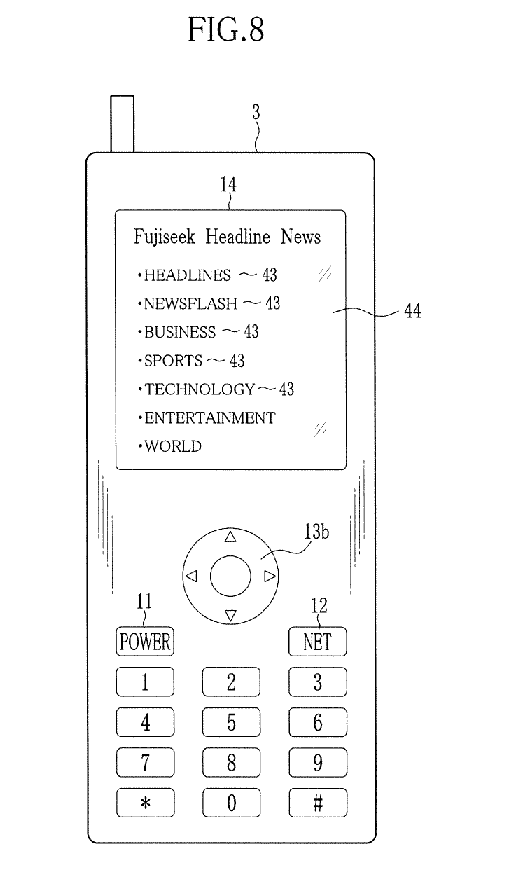

For example, when the user puts the cursor on the pseudo UI elements 33 entitled “news” and then clicks on, an operation signal containing the UI-ID of the pseudo UI element “news”, i.e. UI-ID=1 in the example shown in FIG. 4, and the data indicating that the pseudo UI element 33 is clicked on is transmitted from the mobile phone 3 to the intervening server 4. Based on the received operation signal, the intervening server 4 captures a news web page 35 like as shown in FIG. 6. The converter 25 converts the news web page 35 to image data for displaying a web image 44 corresponding to the web news page 35 on the LCD 14 of the mobile phone 3 (see FIG. 8), and the communication controller 26 transmits the image data of the web image 44 to the mobile phone 3.

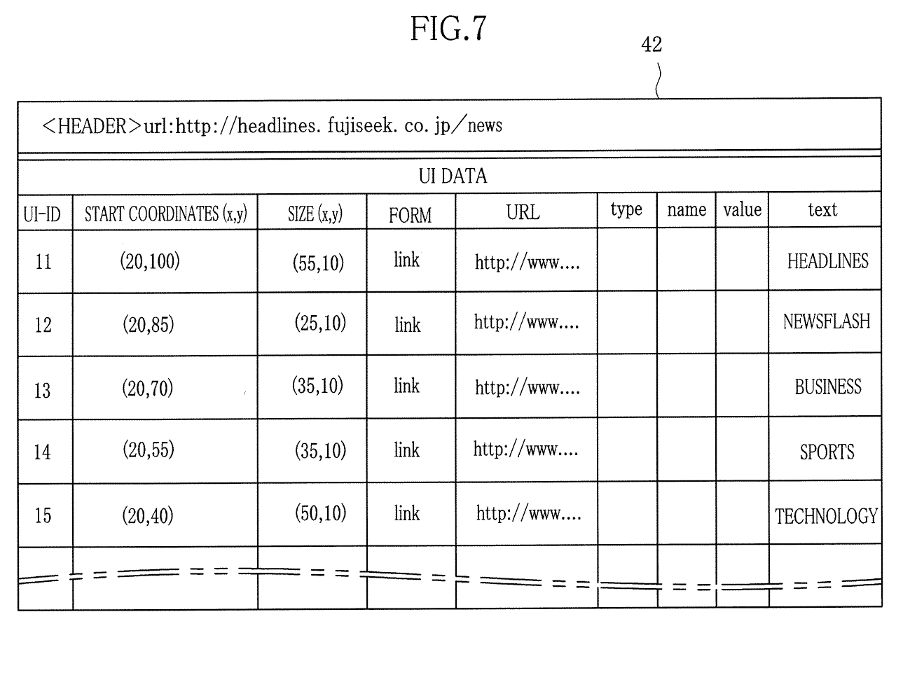

The web news page 35 contains several user interface (UI) elements 41, like the main web page 30 containing the UI elements 31. Referring to FIG. 7 showing user interface (UI) data 42 for constituting the respective UI elements 41 on the web news page 35, the UI data 42 represents information about the individual UI element 41, including an ID of the user interface element 41 (UI-ID), coordinate values of the start position to display the UI element 41 on the web news page 35, the display size of the UI element 41, the form of the UI element 41, a linked. URL address, and attribute values in HTML tags of the UI elements 31.

On the basis of the UI data of the UI element 41, the intervening server 4 produces data for displaying pseudo UI elements 43 on the web image 44, and the communication controller 26 transmits the data for displaying the pseudo UI elements 43 along with the image data for displaying the web image 44 to the mobile phone 3.

As shown in FIG. 8, the mobile phone 3 controls the LCD 14 in response to the data for displaying the pseudo UI elements 43 and the web image 44, to display the web image 44 and the pseudo UI elements 43 superimposed on the web image 44 correspondingly to the UI element 41 on the web news page 35. The pseudo UI elements 43 are also given the same UI-IDs as their counterpart UI elements 41.

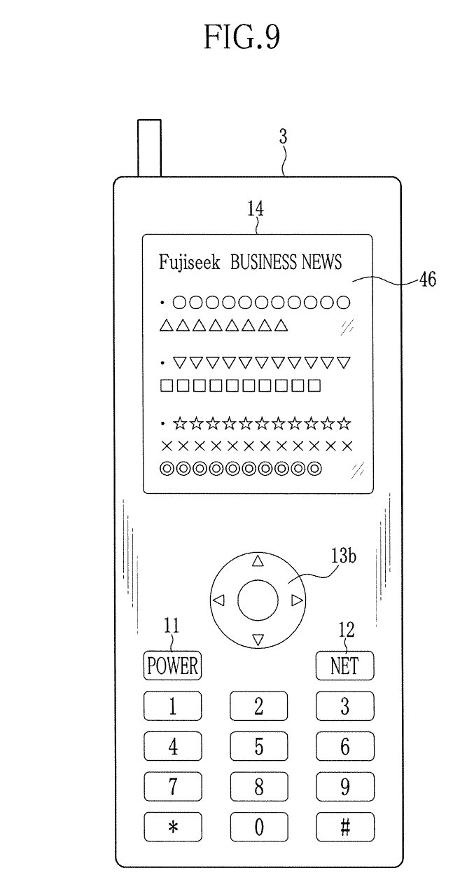

For example, when the user puts the cursor on the pseudo UI elements 43 entitled “business” and then clicks on, an UI operation signal is transmitted from the mobile phone 3 to the intervening server 4. The UI operation signal contains the UI-ID of the pseudo UI element “business”, i.e. “UI-ID=13” in the example shown in FIG. 7, and informs that the pseudo UI element 43 for “business” was clicked on. Based on the received UI operation signal, the intervening server 4 captures a business news page. The converter 25 converts the business news page to image data for displaying a corresponding image 46 on the LCD 14 of the mobile phone 3 (see FIG. 9), and the communication controller 26 transmits the image data of the web image 46 back to the mobile phone 3. Thus, the mobile phone 3 displays the image 46 of the business new web page on the LCD 14, as shown in FIG. 9.

0047-49

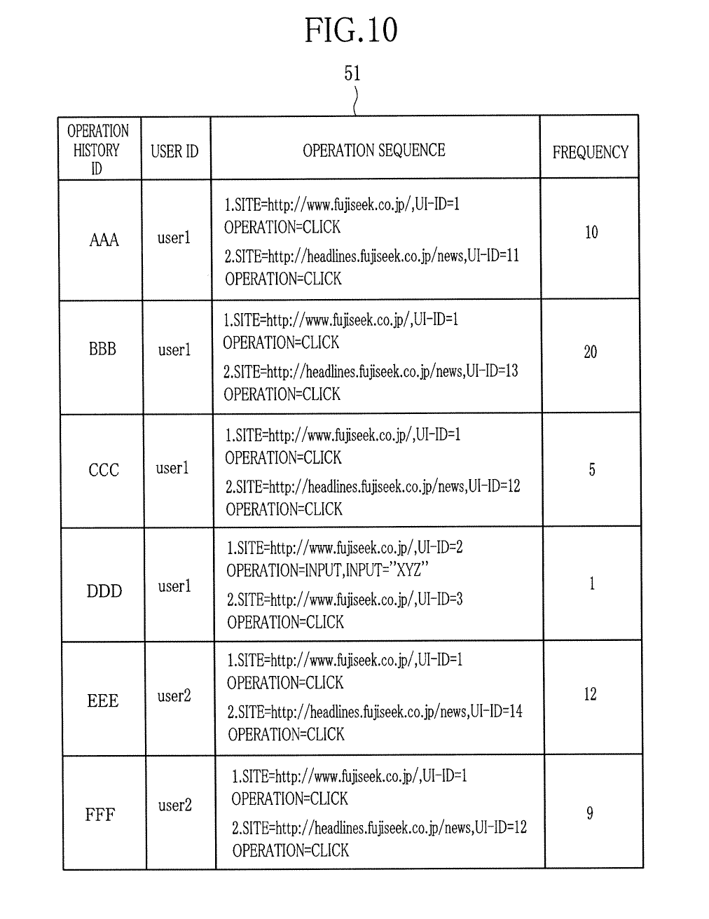

Referring again to FIG. 1, the intervening server 4 further includes an operation history learning section 27, an operation history database 28 and a sorting order controller 29. The operation history database 28 stores operation history data 51 consisting of a plurality of operation histories, as shown for example in FIG. 10. The operation history learning section 27 controls storage or retrieval of the operation history data 51 into or out of the operation history database 28. The sorting order controller 29 controls sorting the operation histories of the operation history data 51.

Each operation history has its own ID, and records a sequence of manual operations done by a particular user, e.g. on a particular mobile phone, in association with a user ID of the particular user, and how many times the particular user has ever executed this operation sequence. The operation histories recorded as the operation history data 51 are sorted according to the users, and arranged in the ascending order of the user ID, i.e. from “user1”, “user2” . . . in the example of FIG. 10.

In this embodiment, when a new operation history is added to the operation history data 51, if the new operation history is associated with the user ID “user1”, the new operation history is recorded after the last operation history among those associated with the user ID “user1”, i.e. the one with an operation history ID “DDD”, and before the first operation history among those associated with the second user ID “user2”, i.e. the one with an operation history ID “EEE”.

The operation sequence may include any manual operations done on the mobile phone 3 during the internet mode, such as clicking or writing a text, except the operation to switch the mobile phone 3 into or out of the internet mode. The operation sequence includes information about a sequence of operations, showing which web site(s) a user accessed and what operation(s) the user made.

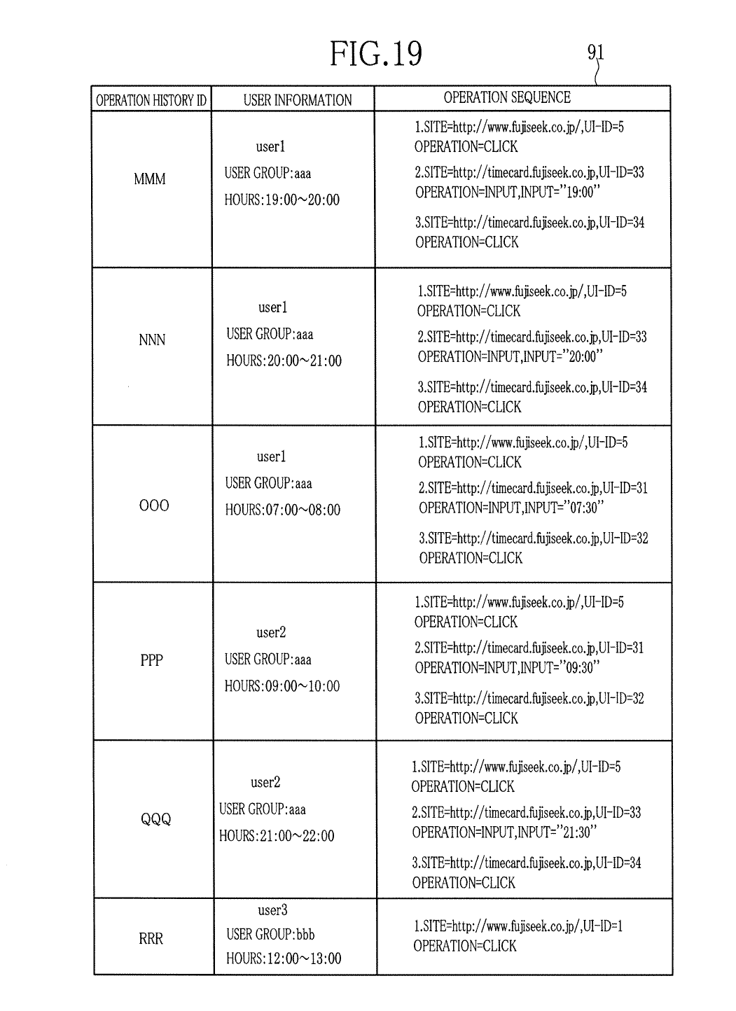

For example, an operation sequence associated with an operation history ID “BBB” includes information about a sequence of operations: the user first clicked on the pseudo UI element 33 of UI-ID=1 (“news”) on the web news page 35 of the main page 30 of a web site named “Fujiseek”, to display the web image 44 having the pseudo UI elements 43 superimposed thereon, as shown in FIG. 8, providing site information contained in a web page entitled “Fujiseek Headline News”; and the user then clicked on the pseudo UI elements 43 of UI-ID=13 (“business”) on the web image 44. Through this operation sequence, site information on a web page “Fujiseek business news” is displayed as a web image 46 on the LCD 14, as shown in FIG. 19.

The operation history learning section 27 also searches the operation history data 51 for those operation history IDs which are associated with the same user ID as a user ID included in operational information newly received from the mobile phone 3. In the example of FIG. 10, when the received user ID is “user1”, the operation history learning section 27 retrieves the operation history IDs “AAA”, “BBB”, “CCC” and “DDD” as being associated with the user ID “user1”. On the other hand, when the received user ID is “user2”, the operation history learning section 27 retrieves the operation history IDs “EEE” and “FFF” as being associated with the user ID “user2”.

The sorting order controller 29 then sorts those operation sequences having the operation history IDs retrieved as above by the operation history learning section 27 in the order of operation frequency, i.e. from most frequently executed to least. In the illustrated embodiment, if the received user ID is “user1”, the sorting order controller 29 sorts the operation sequences executed by the user “user1” in the order of “BBB”, “AAA”, “CCC” and “DDD” in terms of their operation history IDs.

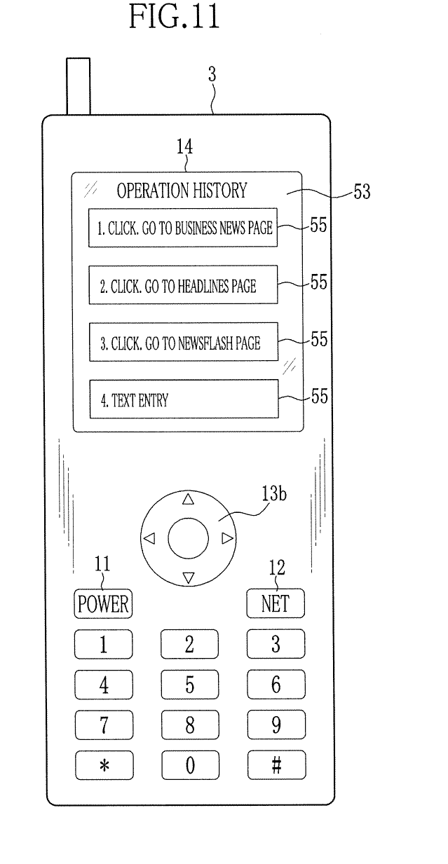

As shown in FIG. 11, the operation sequences or histories sorted by the sorting order controller 29 in the order of operation frequency are converted by the converter 25 to image data for displaying a corresponding operation history list 53 on the LCD 14 of the mobile phone 3. The communication controller 26 transmits the image data for the operation history list 53 back to the mobile phone 3.

The operation history list 53 contains a list of brief operation histories, each consisting of a serial number and a brief summary of the individual operation sequence. The serial number corresponds to the sorting order of the operation sequence; the most often executed operation sequence is numbered “1”, the second most often executed one is “2”, and so forth. The brief summary includes the content of the operation, such as “click” or “text-entry”, and the result or link, such as “go to business news page”.

The operation history learning section 27 also produces data for displaying the brief operation histories as pseudo UI elements 55 on the operation history list 53, which may be referred to as the history UI elements 55 here. The communication controller 26 transmits the data of the pseudo UI elements 55 along with the image data of the operation history list 53 to the mobile phone 3.

The mobile phone 3 controls the LCD 14 in response to the data of the operation history list 53 and the pseudo UI elements 55 from the intervening server 4, to display the operation history list 53 and the pseudo UI elements 55 superimposed on the operation history list 53 in correspondence with the respective brief operation histories. The pseudo UI elements 55 are respectively associated with the corresponding operation history IDs.

When the user operates the operating section 13 to click on one of the history UI elements 55, an operation history ID signal representative of the operation history ID associated with the clicked UI element 55 is transmitted from the mobile phone 3 to the intervening server 4. In responses the operation history ID signal, the operation history learning section 27 of the intervening server 4 retrieves an operation history identified by the received operation history ID from the operation history data 51.

Thus, the same operation sequence as the retrieved operation history is executed. At the same time, the operation history learning section 27 increments the number of times recorded in the operation history that is associated with the received operation history ID, the number of times indicating how many times the corresponding operation sequence has been executed by the same user.

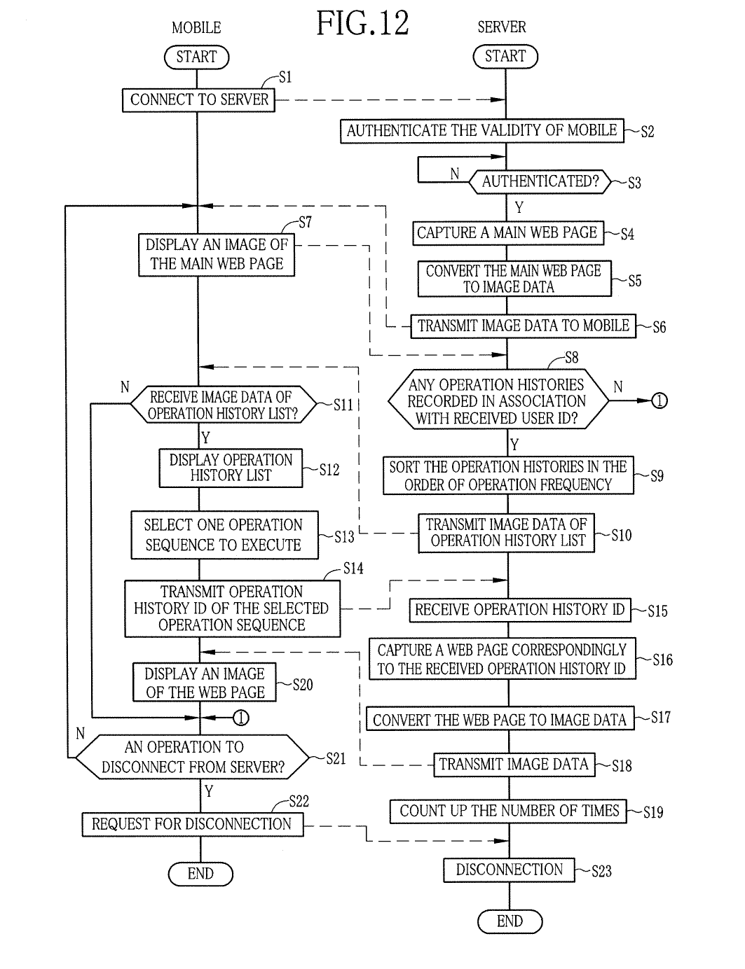

Now the operation of the above first embodiment will be described with reference to the flowchart of FIG. 12. Upon the net button 12 of the mobile phone 3 being operated, the mobile phone 3 moves to the internet mode, where the mobile phone 3 is connected to the intervening server 4 (step S1), and the CPU 16 reads out the user ID of the mobile phone 3 and the URL address of the main page of the web server 5 from the memory 17, to transmit the user ID and the URL address to the intervening server 4.

When the intervening server 4 receives the user ID, e.g. “user1”, the user managing authenticating section 22 determines whether the received user ID coincides with any of the authenticated user IDs, e.g. “user1” to “userl0”, stored in the user authentication database 23 (step S2). When the received user ID coincides with the authenticated use ID (Y=yes in step S3), the converter 25 accesses the web server 5 to capture the main web page 30 from the web server 5 (step S4). The converter 25 converts the main web page 30 to the web image 34 that can be displayed on the LCD 14 (step S5). At the same time, the intervening server 4 produces data for displaying pseudo UI elements 33 corresponding to respective UI elements 31 contained in the main web page 30. The communication controller 26 transmits the data for displaying the pseudo UI elements 33 along with the image data of the web image 34 to the mobile phone 3 (step S6).

In response to the data of the pseudo UI elements 33 and the web image 34 from the intervening server 4, the mobile phone 3 controls the LCD 14 to display the web image 34, and overlays the pseudo UI elements 33 on the web image 34 at corresponding positions to the UI elements 31 on the main web page 30 (step S7).

The operation history learning section 27 of the intervening server 4 searches the operation history data 51 for those operation histories which are associated with the same user ID as the received user ID, and if it there are any (Y=yes in step S8), the sorting order controller 29 sorts the operation sequences of the operation histories as retrieved by the operation history learning section 27 in the order from most frequently executed one to least (step S9).

The converter 25 converts the operation sequences as sorted in the step S9 to data for displaying the operation history list 53. At the same time, the operation history learning section 27 produces data for displaying the brief operation histories as pseudo UI elements 55 on the operation history list 53. The communication controller 26 thus transmits the data of the pseudo UI elements 55 along with the image data of the operation history list 53 to the mobile phone 3 (step S10).

When the mobile phone 3 receives the data of the operation history list 53 and the pseudo UI elements 55 from the intervening server 4 (Y=yes in step S11), the mobile phone 3 controls the LCD 14 on the basis of the received data, to display the operation history list 53 and overlays the pseudo UI elements 55 on the operation history list 53 at corresponding positions to the brief operation histories (step S12). Thus, the operation sequences that have been executed by the user of the mobile phone 3 are displayed on the LCD 14 in the order executed most frequently to least. Accordingly, the user does not need to make a search for these operation sequences.

When the user operates the operating section 13 to click on a desired one of the pseudo UI elements 55, e.g. “1. Click. Go to business new page” (step S13), an operation history ID signal representative of the operation history ID of the clicked pseudo UI element 55, i.e. “BBB” in this example, is transmitted from the mobile phone 3 to the intervening server 4 (step S14). When the intervening server 4 receives the operation history ID signal (step S15), the intervening server 4 captures a web page, i.e. the business news page in this example, correspondingly to the operation sequence of the received ID (step S16).

The converter 25 converts the business news page to image data for displaying a web image 46 on the LCD 14 corresponding to the business new page (step S17). The communication controller 26 transmits the image data of the web image 46 to the mobile phone 3 (step S18). Simultaneously, the operation history learning section 27 counts up the number of times of execution of the operation sequence that is associated with the received operation history ID, i.e. “BBB” in this instance, in the operation history data 51 (step S19).

Receiving the image data of the web image 46 from the intervening server 4, the mobile phone 3 controls the LCD 14 to display the web image 46 (step S20). When the user operates the operating section 13 to disconnect or logout the mobile phone 3 from the intervening server 4 (Y=yes in step S21), the CPU 16 transmits a disconnection request signal to the intervening server 4 (step S22), upon which the intervening server 4 disconnects from the mobile phone 3 (step S23).

### Second Embodiment

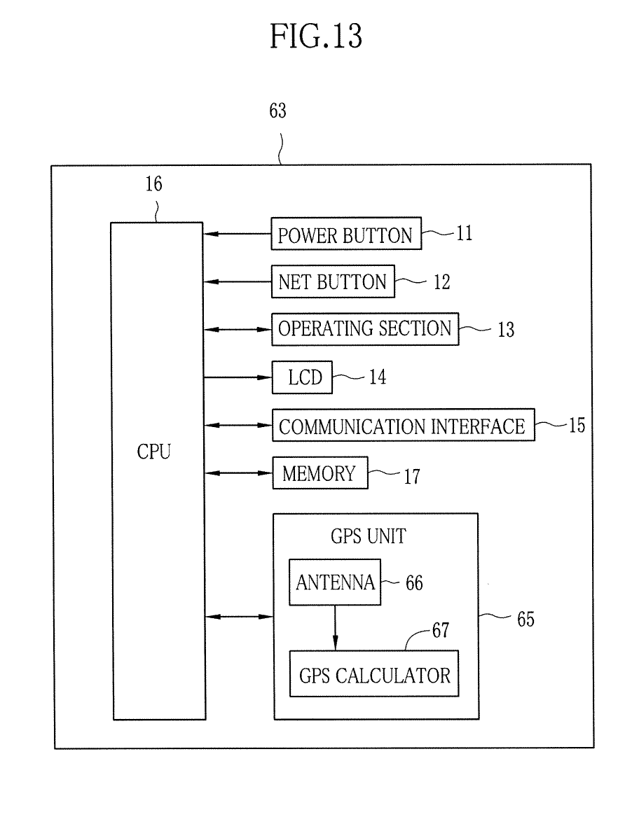

In a second embodiment shown in FIGS. 13 to 18, a web browsing system is configured to sort operation histories on the basis of a present location of a mobile terminal, e.g. a mobile phone 63, that is connected to an intervening server 4. Note that the web browsing system may include a plurality of mobiles phones 63 although the following description merely refer to one of these mobile phones 63.

Other components of the second embodiment than the mobile phone 63 may be the same as or equivalent to those of the first embodiment. In the second embodiment, the same or equivalent components are designated by the same reference numerals as in the first embodiment, and their details are omitted unless it is necessary.

As shown in FIG. 13, the mobile phone 63 is equipped with a GPS unit 65 for obtaining information about its present location. The GPS unit 65 has an antenna 66 and a GPS calculator 67. The antenna 66 is configured to receive electric waves from four or more of the converter 25 satellites of the global positioning system (GPS), which are orbiting the earth. The received electric waves are sent to the GPS calculator 67. The GPS calculator 67 contains a calculation program for calculating data of the present location, i.e. latitude and longitude, on the basis of the received electric waves.

When the mobile phone 63 is switched to the internet mode, a CPU 16 outputs a program activation signal to the GPS calculator 67. Then, the GPS calculator 67 activates the calculation program to calculate data of the present location of the mobile phone 63 on the basis of the electric waves simultaneously received from for example four GPS satellites, the four electric waves representing distances from the GPS satellites to the mobile phone 63. When the mobile phone 63 gets authenticated by the intervening server 4, the CPU 16 transmits the location data indicating the present location of the mobile phone 63 to the intervening server 4.

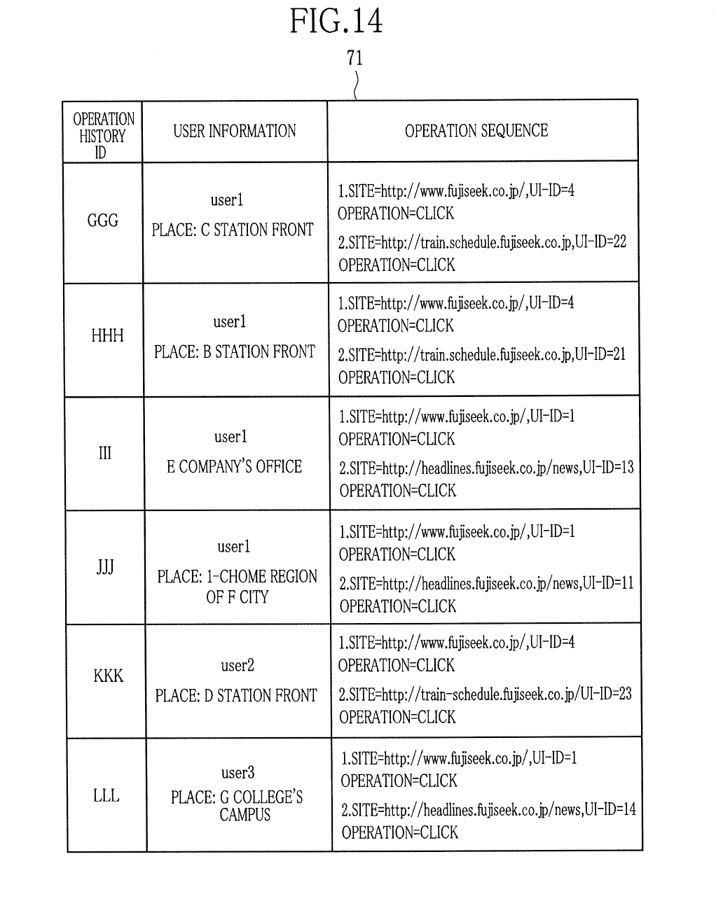

On the other hand, as shown in FIG. 14, an operation history learning section 27 of the intervening server 4 produces operation history data 71 and stores it in an operation history database 28. The operation history data 71 includes a plurality of operation histories, each recording an operation sequence in association with an operation history ID and user information. The user information includes a user ID and location data transmitted from an individual mobile phone 63 each time it is connected to the intervening server 4. Thus, the location data represents an access location at which the corresponding operation sequence was executed through the individual mobile phone 63.

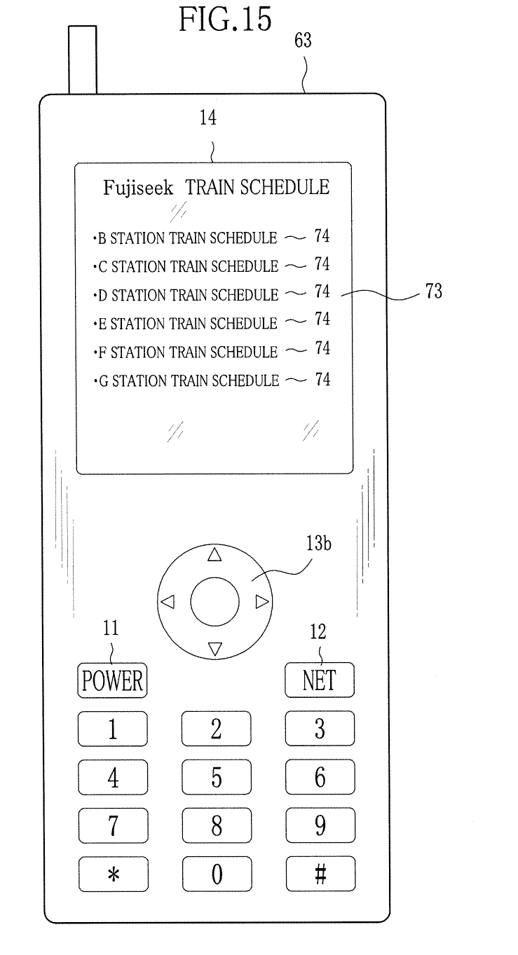

For example, when a user clicks on a pseudo UI element 33 corresponding to an option “train schedule” on a main web image 34 displayed on an LCD 14 of a mobile phone 63, a corresponding user interface ID, UI-ID=4 in the example of FIG. 4, is transmitted from the mobile phone 63 to the intervening server 4. As a result, a web image 73 corresponding to a web page for train schedules appears on the LCD 14 of the mobile phone 63, as shown in FIG. 15. The web image 73 has pseudo UI (user interface) elements 74 superimposed thereon in correspondence with several options “B station train schedule”, “C station train schedule” etc.

Note that control steps from clicking on the pseudo UI elements 33 “time schedule” to displaying the web image 73 and the pseudo UI elements 74 on the LCD 14 of the mobile phone 63 may be equivalent to the above described steps from clicking on the pseudo UI elements 33 “news” to displaying the pseudo UI elements 43 and the web image 44 on the LCD 14 in the first embodiment.

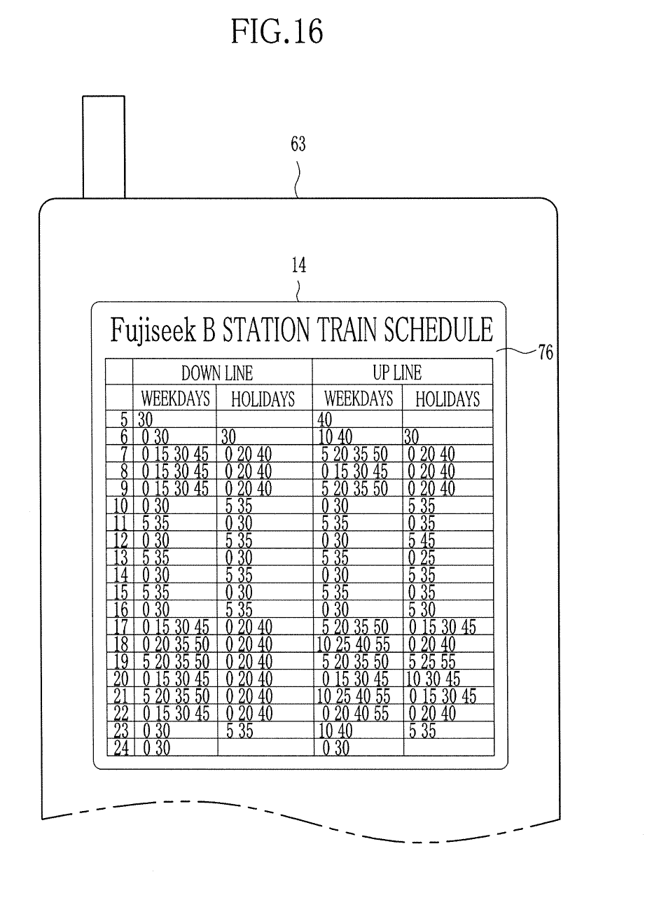

Thereafter when the user clicks on one pseudo UI element 43, e.g. one entitled “B station train schedule”, an operational signal representative of a corresponding UI-ID is transmitted from the mobile phone 63 to the intervening server 4, so the intervening server 4 captures a web page containing B station train schedule. A converter 25 converts the web page containing B station train schedule to image data for displaying a web image 76 containing B station train schedule on the LCD 14 (see FIG. 16), and the communication controller 26 transmits the image data of the web image 76 back to the mobile phone 63. Thus, the mobile phone 63 displays the web image 76 on the LCD 14 on the basis of the image data from the intervening server 4.

In an example shown in FIGS. 14 and 15, the pseudo UI element 74 corresponding to “B station train schedule” is given a user interface ID of UI-ID=21. Likewise, other pseudo UI elements 74 for “C station train schedule” to “G station train schedule” on the web image 73 have their user interface IDs of UI-ID=22 to 26, respectively.

In the operation history data 71, an operation sequence associated with an operation history ID “HHH” includes information about a series of operations: the user first clicked on the pseudo UI element 33 of UI-ID=4 (“train schedule”) on a main page of a web site named “Fujiseek”, to display a web image 73 having the pseudo UI elements 74 superimposed thereon, as shown in FIG. 15, providing site information on a web page entitled “Fujiseek Train Schedule”; and the user then clicked on the pseudo UI elements 74 of UI-ID=21 (“B station train schedule”) on the web image 73. Through this operation sequence, a web image 76 is displayed on the LCD 14, as shown in FIG. 16, containing site information on a web page entitled “Fujiseek B Station Train Schedule”

The operation history learning section 27 also searches the operation history data 71 for those operation history IDs which are associated with the same user ID as a user ID newly received from the mobile phone 63. In the example shown in FIG. 14, when the received user ID is “user1”, the operation history learning section 27 retrieves the operation history IDs “GGG”, “HHH”, “III” and “JJJ” as being associated with the user ID “user1”.

In the second embodiment, operation sequences associated with the operation history IDs as retrieved by the operation history learning section 27, i.e. operation sequences associated with the same user ID as received from the mobile phone 63, are sorted by a sorting order controller 29 on the basis of location data newly received from the mobile phone 63.

For example, if the location data from the mobile phone 63 represents “B station front”, the sorting order controller 29 sorts the operation sequences retrieved from the operation history data 71 in the order of increasing distance from the B station in view of the access locations where the respective operation sequences were executed.

Provided that the distances from “B station front” to “E office”, “C station front” and “1-chome region of F city” increase in the order named, and that the user ID “user1” and the location data “B station front” are received, the sorting order controller 29 sorts the retrieved operation sequences in the order of “HHH” “III”, “GGG” and “JJJ” in terms of their operation history IDs (see FIG. 14).

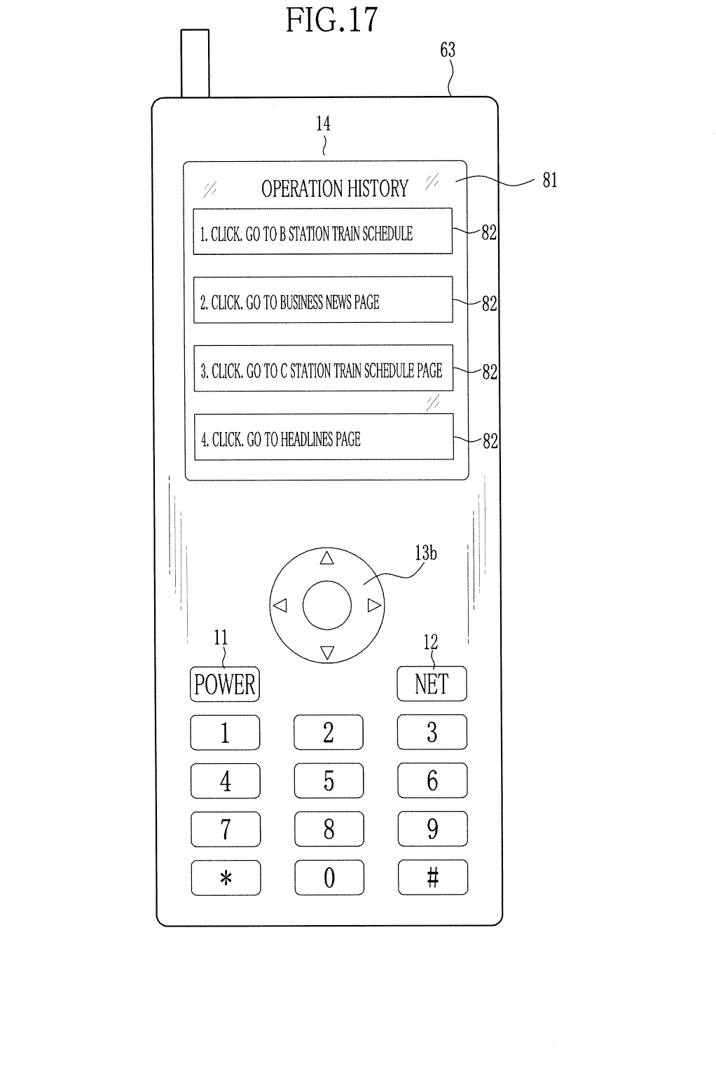

The operation sequences or histories sorted by the sorting order controller 29 in ascending order of distance from the present location of the mobile phone 63 are converted by the converter 25 to image data for displaying a corresponding operation history list 81 on the LCD 14 of the mobile phone 63, as shown in FIG. 17.

The operation history list 81 contains a list of brief operation histories, each consisting of a serial number and a brief summary of the individual operation sequence. The serial number corresponds to the sorting order of the operation sequence; the operation sequence executed at the nearest access location to the present location is numbered “1”, one executed at the second nearest access location is “2”, and so forth. The brief summary includes the content of the operation, such as “click” or “input text”, and the link or result.

The communication controller 26 transmits the image data of the operation history list 81 to the mobile phone 63. Thus, the operation history list 81 is displayed on the LCD 14 of the mobile phone 63, and pseudo UI elements 82 are superimposed on the operation history list 81 in correspondence with the brief operation histories, such as “1. Click. Go to B station train schedule page” and “2. Click. Go to business news page”. The pseudo UI elements 82 are respectively associated with the corresponding operation history IDs. Note that the LCD 14 is controlled to display the operation history list 81 and the pseudo UI elements 82 in the same way as for the operation history list 53 and 55 in the first embodiment.

When the user operates the operating section 13 to click on one of the pseudo UI elements 82, an operation history ID signal representative of an operation history ID associated with the clicked pseudo UI element 82 is transmitted from the mobile phone 63 to the intervening server 4. When the intervening server 4 receives the operation history ID signal, the operation history learning section 27 retrieves an operation history that is associated with the same ID as the received operation history ID from among the operation history data 71. Then, the operation sequence of the retrieved operation history is executed.

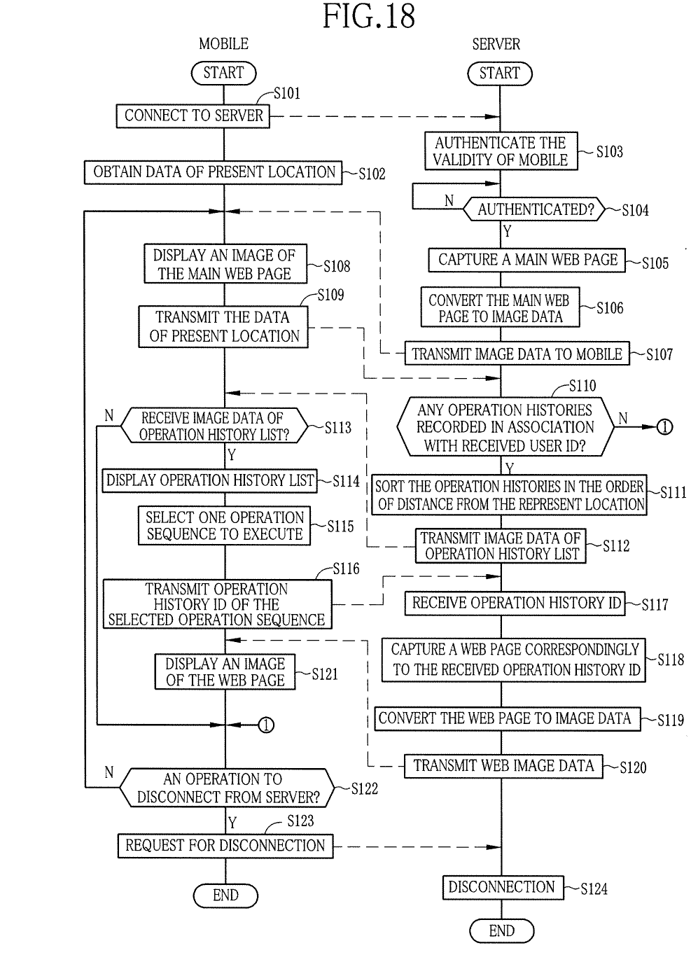

Now the operation of the second embodiment will be described with reference to the flowchart of FIG. 18.

When the mobile phone 63 is connected to the intervening server 4 (step S101), the user ID is transmitted from the mobile phone 63 to the intervening server 4 and, at the same time, the GPS unit 65 calculates location data representative of a present location of the mobile phone 63 (step S102).

The following steps S103 to S108 are equivalent to the steps S2 to S7 of the first embodiment, so these steps will be briefly described. The following description of the second embodiment assumes that the user ID received from the mobile phone 63 is “user1” and the location data indicates “B station front”.

After the LCD 14 displays the pseudo UI elements 33 on the web image 34 correspondingly to the UI elements 31 on the main web page 30 (step S108), the location data (“B station front”) obtained at the GPS unit 65 is transmitted to the intervening server 4 (step S109). The following steps S110 to S121 are similar to the steps S8 to S20 of the first embodiment, so the description of these steps is omitted.

If the operation history data 71 includes any operation sequences that are associated with the received user ID (Y=yes in step S110), the sorting order controller 29 sorts these operation sequences with reference to the location data from the mobile phone 63 according to the increasing distance from the present location of the mobile phone 63 (“B station front”) to the respective access locations at which the user “user1” executed these operation sequences (step S111). In the example of FIG. 14, the sorting order controller 29 sorts the operation sequences in the order of “HHH”, “III”, “GGG” and “JJJ” in terms of their operation history IDs.

The converter 25 converts the operation sequences as sorted this way to image data for displaying an operation history list 81, and the image data of the operation history list 81 and the data for displaying the pseudo UI elements 82 are transmitted from the intervening server 4 to the mobile phone 63 (step S112).

Thus, those operation sequences which have been executed by the same user of the mobile phone 63 are displayed as a list of the brief operation histories on the LCD 14 in the order executed at the nearest location to the present location of the mobile phone 63 first. Therefore, it becomes easy for the user to find any operation sequences that the user previously executed in the vicinity of the present location.

When the mobile phone 63 receives the image data of the operation history list 81 and the data for displaying the pseudo UI elements 82 from the intervening server 4 (Y=yes in step S113), the operation history list 81 is displayed on the LCD 14, and the pseudo UI elements 82 are superimposed on the operation history list 81 in the corresponding positions (step S114).

When the user operates the operating section 13 to click on a desired one of the pseudo UI elements 82, e.g. “1. Click. Go to B station train schedule” (step S115), an operation history ID signal representative of the operation history ID of the clicked pseudo UI element 82, i.e. “HHH” in this example, is transmitted from the mobile phone 63 to the intervening server 4 (step S116).

Upon receipt of the operation history ID signal (step S117), the intervening server 4 executes the operation sequence corresponding to the received operation history ID “HHH”, capturing a web page, i.e. a web page for B station trains schedule in this example (step S118). The web page for B station train schedule is converted to image data for displaying a corresponding web image 76 on the LCD 14 (step S119), and the image data of the web image 76 is transmitted to the mobile phone 63 (step S120).

The mobile phone 63 displays the web image 76 on the LCD 14 on the basis of the received image data (step S121). The following steps S122 to S124 are similar to the steps S21 to S23 in the first embodiment, so the description of these steps is omitted.

### Third Embodiment

A web browsing system of a third embodiment is illustrated in FIGS. 19 to 23, wherein those operation histories which are associated with both the same user group and the same operation as indicated by operational information from an individual user terminal are retrieved from operation history data, and the retrieved operation histories are sorted in the order determined based on their access times, that is, the hours the operation sequences of these item were executed.

The third embodiment may be constructed by the same components as the first embodiment. These components are designated by the same reference numerals as in the first embodiment, and their detailed description is omitted unless it is necessary.

As shown in FIG. 19, an operation history learning section 27 produces operation history data 91 and stores the data 91 in an operation history database 28. The operation history data 91 includes a plurality of operation histories, each recording an operation sequence in association with an operation history ID and user information. The user information includes a user ID, a user group, and time data indicating an access time (an hour) at which an individual mobile phone 3 was connected to an intervening server 4. In the example of FIG. 19, first and second users with IDs “user1” and “user2” belong to the same user group “aaa”, whereas a third user with ID “user3” belongs to another user group “bbb”.

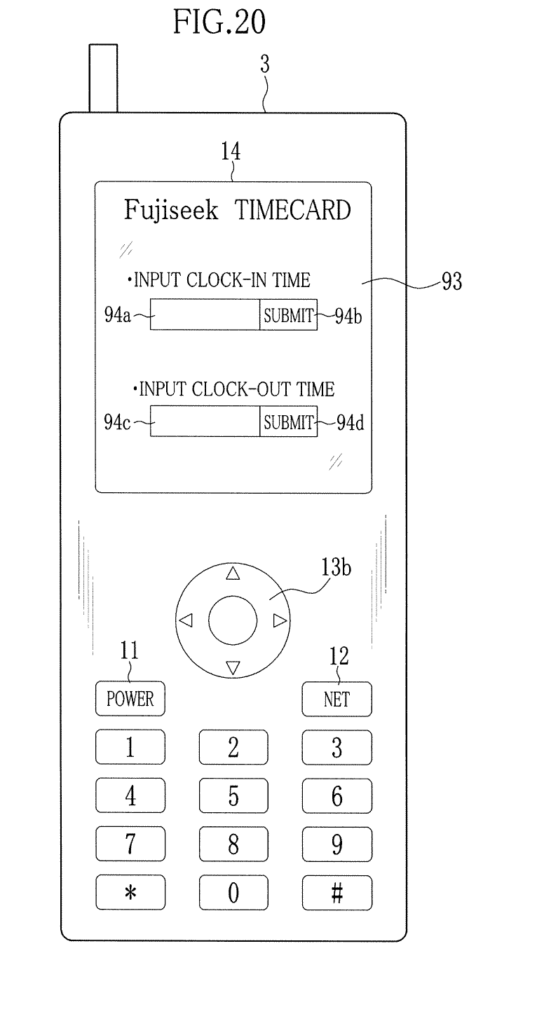

When a user clicks on a pseudo UI element 33 corresponding to an option “timecard” on a main web image 34 displayed on an LCD 14 of a mobile phone 3 (see FIG. 5), a corresponding user interface ID, UI-ID=5 in the example of FIG. 4, is transmitted to the intervening server 4. As a result, a web image 93 corresponding to a web page for timecard appears on the LCD 14, as shown in FIG. 20. Superimposed on the web image 93, pseudo UI (user interface) elements 94a, 94b, 94c and 94d are also displayed on the LCD 14. The pseudo UI element 94a serves as a text box for entering a clock-in time, the pseudo UI element 94b serves as a submit button for submitting the entered clock-in time, the pseudo UI element 94c serves as a text box for entering a clock-out time, and the pseudo UI element 94b serves as a submit button for submitting the entered clock-out time.

Note that control steps from clicking on the pseudo UI elements 33 “timecard” to displaying the web image 93 and the pseudo UI elements 94a to 94d on the LCD 14 may be equivalent to the above described steps from clicking on the pseudo UI elements 33 “news” to displaying the pseudo UI elements 43 and the web image 44 on the LCD 14 in the first embodiment.

For example, when the first user “user1” enters a clock-out time “19:00” in the text box as the pseudo UI element 94c, and then clicks on the submit button as the pseudo UI element 94d, an UI operation signal is transmitted from the mobile phone 3 to the intervening server 4, including the user interface ID (UI-ID) of the pseudo UI elements 94c and 94d, and indicating that the time “19:00” was entered in the text box 94c and the submit button 94d was clicked on. In response to the received UI operation signal, the intervening server 4 registers the clock-out time “19:00” of the user “user1” in a not-shown timecard memory of a web server 5.

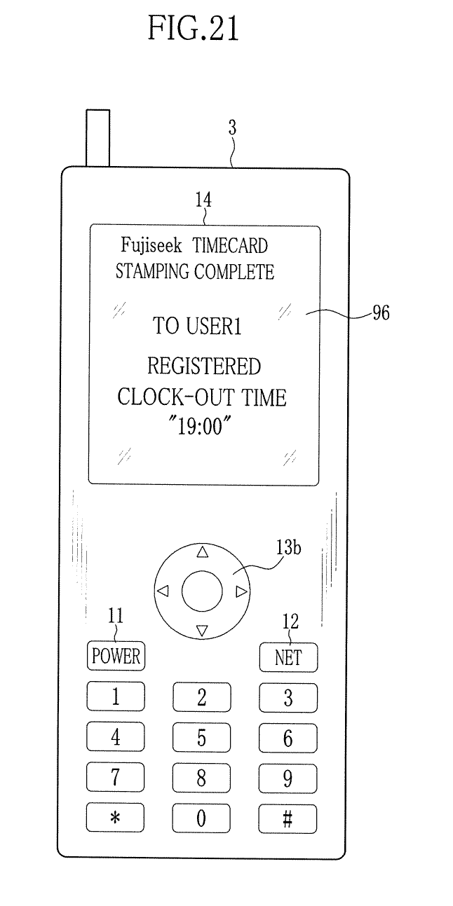

Simultaneously, the intervening server 4 captures a web page from the web server 5, the web page notifying that the corresponding operation sequence has been executed to complete registering the clock-out time in the timecard memory. This web page is converted to image data for displaying a corresponding image 96 on the mobile phone 3 (see FIG. 21), and the image data is transmitted to the mobile phone 3. Thus, the LCD 14 of the mobile phone 3 displays the web image 96 notifying the completion of stamping the clock-out time in the timecard of the corresponding user, as shown in FIG. 21.

In the example shown in FIG. 19, the pseudo UI element 94a for entering a clock-in time is given a user interface ID of UI-ID=31, the pseudo UI element 94b for submitting the entered clock-in time is UI-ID=32, the pseudo UI element 94c for entering a clock-out time is UI-ID=33, and the pseudo UI element 94b for submitting the entered clock-out time is UI-ID=34.

For example, an operation sequence associated with an operation history ID “MMM” includes information about a sequence of operations: the user first clicked on the pseudo UI element 33 of UI-ID=5 (“timecard”) on the web image 35 of the main page 30 of the web site named “Fujiseek”, to display the web image 93 having the pseudo UI elements 94a to 94d superimposed thereon, as shown in FIG. 20, providing site information contained in a web page entitled “Fujiseek Timecard”; and the user then entered a clock-out time “19:00” in the pseudo UI element 94c of UI-ID=33 and clicked on the pseudo UI element 94d on the web image 93 for submitting the entered clock-out time.

Through this operation sequence, the intervening server 4 registers the clock-out time “19:00” of the user “user1” in the timecard memory of the web server 5, and the web image 96 notifying the completion of stamping the clock-out time is displayed as the web image 96 on the LCD 14, as shown in FIG. 21.

In the third embodiment, the operation history learning section 27 searches the operation history data 91 for those operation histories which are associated with user IDs of the same user group as a user ID received from the mobile phone 3 belongs to, and also the same initial operation data as initial operation data received from the mobile phone 3.

For example, when the received user ID is “user1” and the initial operation data indicates that the user clicked on “timecard (UI-ID=5)” on the web image 34 of the main page 30 of “Fujiseek”, the operation history learning section 27 retrieves operation histories with IDs “MMM”, “NNN”, “000” “PPP” and “QQQ” as being associated with the same user group “aaa” as the received user ID “user1” belongs to, and recording the same initial operation “timecard click” as indicated by the received initial operation data (UI-ID=5) as well. On the contrary, as being not associated with the same user group “aaa” as the received user ID, an operation history with ID “RRR” is not retrieved.

The sorting order controller 29 sorts the operation sequences of the retrieved operation history IDs according to their time data with reference to the present access time of the mobile phone 3 being newly connected to the intervening server 4. Specifically, an operation sequence that was executed at an hour proximate to the present access time is first, and one executed at an hour most distant from the present access time is last.

As shown in FIG. 19, the operation history “MMM” includes time data indicating “19:00-20:00” as a period during which the user “user1” accessed the intervening server 4, and the operation history “NNN” includes time data indicating “20:00-21:00” as a period during which the user “user1” accessed the intervening server 4. Likewise, the operation history “000” includes time data indicating “07:00-08:00”, the operation history “PPP” includes time data indicating “09:00-10:00”, and the operation history “QQQ” includes time data indicating “21:00-22:00”.

In that case, when “user1” and “UI-ID=5 (timecard click)” are received as the user ID and the initial operation data from the mobile phone 3, and the present access time of the mobile phone 3 to the intervening server 4 is “19:20”, the retrieved operation sequences are sorted in the order of “MMM”, “NNN”, “QQQ”, “PPP” and “OOO” in terms of their operation history IDs.

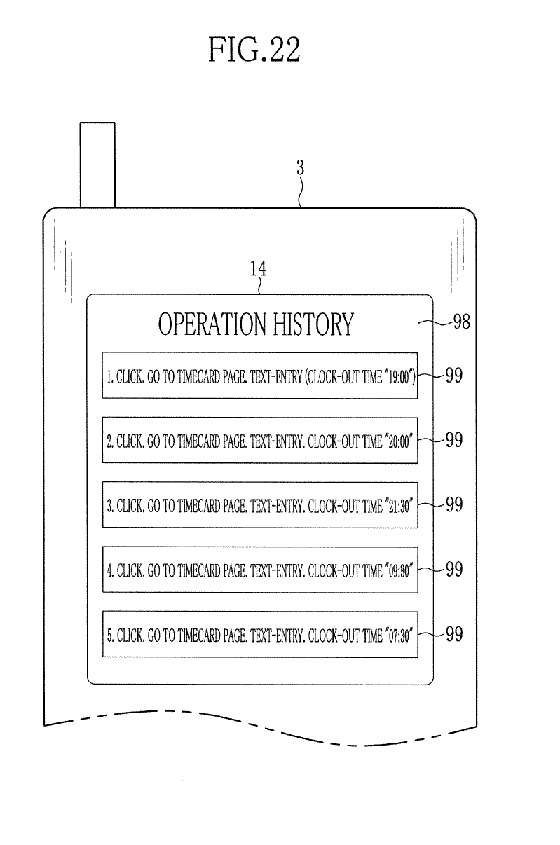

As shown in FIG. 22, the operation sequences sorted in the order of proximity of their access time to the present access time of the mobile phone 3 to the intervening server 4 is converted to image data for displaying an operation history list 98 on the LCD 14 of the mobile phone 3. The image data is transmitted from the intervening server 4 to the mobile phone 3, to display the operation history list 98 on the LCD 14.

The converter 25 converts the operation sequences to the image data of the operation history list 98, such that the operation history list 98 contains a list of brief operation histories, each consisting of a serial number (1, 2, 3 . . . ) and a brief summary of the individual operation sequence. The serial number corresponds to the sorting order of the operation sequence. The brief summary includes the content of the operation, such as “click” or “text-entry”, and the result of the operation, such as “Go to timecard page” or “clock-out time 19:00”. The communication controller 26 transmits the image data of the operation history list 98 to the mobile phone 3.

Thus, the operation history list 98 is displayed on the LCD 14, and pseudo UI elements 99 are superimposed on the operation history list 98 in correspondence with the respective brief operation histories, such as “1. Click. Go to timecard page. Text-entry. Clock-out time 19:00” and “2. Click. Go to timecard page. Text-entry. Clock-out time 20:00”.

The pseudo UI elements 99 are respectively associated with the corresponding operation history IDs. Note that the LCD 14 is controlled to display the operation history list 98 and the pseudo UI elements 99 in the same way as for the operation history list 53 and 55 in the first embodiment.

When the user operates the operating section 13 to click on one of the pseudo UI elements 99, e.g. “1. Click. Go to timecard page. Text-entry. Clock-out time 19:00”, an operation history ID signal representative of the operation history ID associated with the clicked pseudo UI element 99, e.g. “MMM”, is transmitted from the mobile phone 3 to the intervening server 4. When the intervening server 4 receives the operation history ID signal, the operation history learning section 27 searches the operation history data 91 for the same operation history ID as the operation history ID received from the mobile phone 3, e.g. “MMM”. Then, the operation sequence of the retrieved operation history ID is executed.

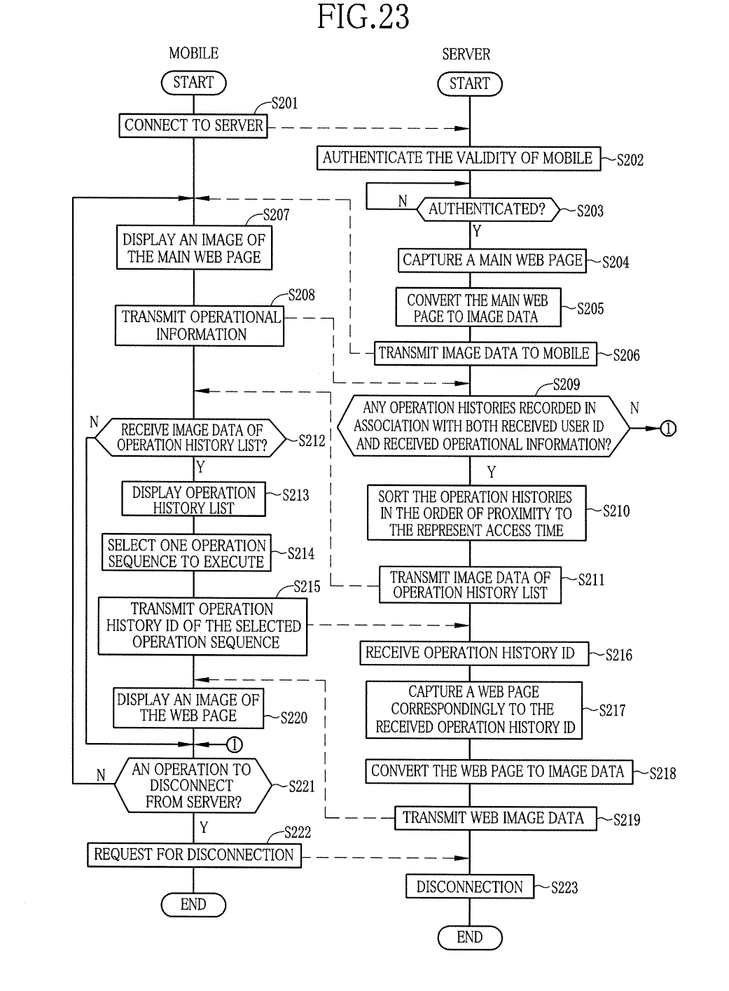

Now the operation of the third embodiment will be described with reference to the flowchart of FIG. 23.

When the mobile phone 3 is connected to the intervening server 4 (step S201), the user ID is transmitted from the mobile phone 3 to the intervening server 4. The following steps S202 to S207 are equivalent to the steps S2 to S7 of the first embodiment, so the description of these steps is omitted.

The following operation of the third embodiment will be described on the assumption that the present access time of the mobile phone 3 to the intervening server 4 is “19:20”, the user ID is “user1” and the initial operation data from the mobile phone 3 represents “timecard click”.

After the LCD 14 displays the pseudo UI elements 33 on the web image 34 correspondingly to the UI elements 31 on the main web page 30 (step S207), the user clicks on one of the pseudo UI elements 33 that is entitled “timecard” (UI-ID=5). Then, initial operation data “timecard click” is transmitted to the intervening server 4 (step S208). The following steps S209 to S220 are similar to the steps S8 to S20 of the first embodiment, so these steps will be briefly described.

If the operation history data 91 includes any operation sequences that are associated with both the same user group “user group aaa” as the received user ID “user1”, and the received initial operation data “timecard click” (Y=yes in step S209), the sorting order controller 29 sorts these operation sequences with reference to the present access time of the mobile phone 3 to the intervening server 4, e.g. “19:20”, in the order of proximity of their access time to the present access time. In this example, the operation sequences are sorted in the order of “MMM”, “NNN”, “QQQ”, “PPP” and “OOO” in terms of their operation history IDs.

The converter 25 converts the operation sequences as sorted this way to image data for displaying an operation history list 98, and the image data of the operation history list 98 and the data for displaying the pseudo UI elements 99 are transmitted from the intervening server 4 to the mobile phone 3 (step S211).

Thus, those operation sequences which have been executed by the users of the same group in response to the same initial operation, e.g. “timecard click”, are displayed as a list of the brief operation histories on the LCD 14 in the order from most proximate to the present access time to least. Therefore, it becomes easy for the user to find any operation sequences that the users of the same group previously executed at an hour around the present access time of the mobile phone 3 to the intervening server 4.

When the mobile phone 3 receives the image data of the operation history list 98 and the data for displaying the pseudo UI elements 99 from the intervening server 4 (Y=yes in step S212), the operation history list 98 is displayed on the LCD 14, and the pseudo UI elements 99 are superimposed on the operation history list 98 in the corresponding positions (step S213).

When the user operates the operating section 13 to click on a desired one of the pseudo UI elements 99, e.g. “1. Click. Go to timecard page. Text-entry. Clock-out time 19:00” (step S214), an operation history ID signal representative of the operation history ID associated with the clicked pseudo UI element 99, e.g. “MMM”, is transmitted from the mobile phone 3 to the intervening server 4.

When the intervening server 4 receives the operation history ID signal (step S216), the intervening server 4 executes the operation sequence corresponding to the received operation history ID (“MMM”) to register the clock-out time “19:00” of the user “user1” in the timecard memory of the web server 5, and then the intervening server 4 captures the web page notifying of the completion of registering the clock-out time (step S217). This web page is converted to image data for displaying a corresponding image 96 on the mobile phone 3 (step S218), and the image data is transmitted to the mobile phone 3 (step S219).

The mobile phone 3 displays the web image 96 on the LCD 14 on the basis of the received image data (step S220). The following steps S221 to S223 are similar to the steps S21 to S23 in the first embodiment, so the description of these steps is omitted.

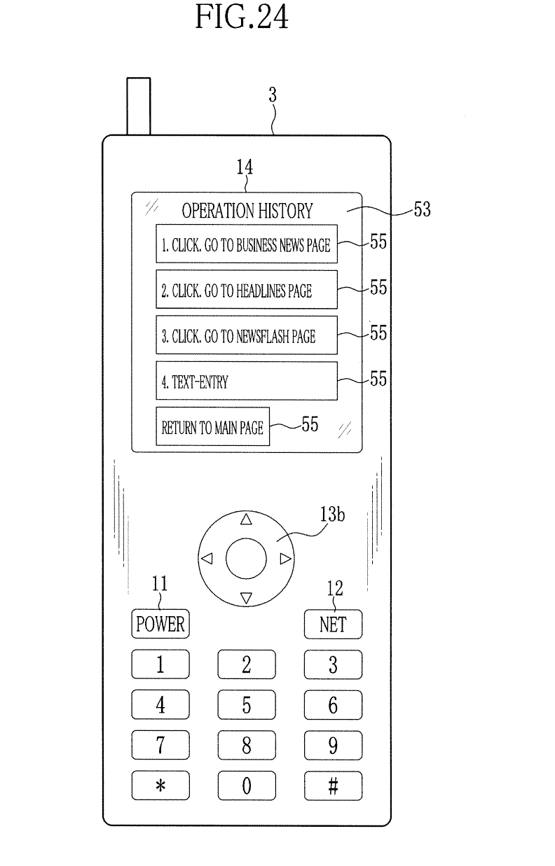

In another embodiment, as shown in FIG. 24, a button for returning to the main page 30, i.e. for displaying the web image 34 of the main page 30 again on the LCD 14, may be included in the pseudo UI elements 55 on the operation history list 53. In this embodiment, data for displaying the button “return to main page” as a pseudo UI element is included the data for displaying other pseudo UI elements 55, to be superimposed on the operation history list 53. When the user clicks on the “return to main page” button 55, the CPU 16 controls the LCD 14 to display the web image 34.

Thus, the user may also browse those web pages which are not recorded in the operation history. In the same way as for the operation history list 53, a “return to main page” button may be displayed as a pseudo UI element on the operation history list 81 or 98.

In the above third embodiment, those operation histories which are associated with both the same user group and the same initial operation as the operational information from the user are retrieved, and all of them are converted to the operation history list 98. However, the operation sequences to be displayed on the user terminal may also be limited by their access times. For example, it is possible to convert and display merely those operation sequences which were executed within a predetermined time, e.g. six hours, from the present access time of the user to the server.

Moreover, the third embodiment is configured to display the web image 93 on the LCD 14 in response to a click on the pseudo UI element 33 for “timecard”. Alternatively, a screen for choosing a company or organization may be displayed prior to the web image 93, in response to the pseudo UI element “timecard” being clicked on. Thus, the timecard stamping service may be provided for a plurality of companies and organizations.

The order of sorting the operation sequences in the operation history list may be modified appropriately. For example, they may be sorted in ascending order of operation frequency, in the order of decreasing distance from the present access location, or in descending order of proximity to the present access time, although they are sorted in the reverse order in the first to third embodiments respectively.

The order of sorting the operation sequences may be determined based on at least one of the operation frequency, the access location and the access time. That is, the sorting order may be determined based on two or all of these factors. Moreover, not only hours but also seasons and weekdays may be taken account of in sorting the operation sequences based on their access time.

In the above embodiment, image data for displaying an operation history list is produced from the operation sequences retrieved and sorted each time a user ID is received from a user terminal. However, image data of an operation history list may be previously produced for each user ID and stored in the operation history database.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A web browsing system comprising:
a mobile terminal and an intervening server connectable to each other over a network, wherein
said mobile terminal comprising:
an input device operated to input operational information; and
a display device that displays images including various information; and
said intervening server comprising:
an authenticating device that authenticates the user of said mobile terminal on the basis of terminal information about said mobile terminal when said terminal information is received from said mobile terminal;
a web page capturing device that captures a web page from a web server in accordance with operational information from said mobile terminal when said mobile terminal is authenticated by said authenticating device;
a converter that converts said web page to image data for displaying a web image corresponding to said web page on said display device of said mobile terminal;
a device that produces data for displaying user interface elements on said web image, said user interface elements having the same function as user interface elements provided on said web page;
a history storage device that stores operation histories each recording a sequence of operational information received from an authenticated mobile terminal in association with terminal information about said authenticated mobile terminal;
a retrieving device that retrieves, each time said mobile terminal is authenticated, those operation histories which are stored in association with the terminal information of said authenticated mobile terminal from said history storage device;
a sorting device that sorts the retrieved operation histories in the order determined based on communicative conditions between said mobile terminal and said intervening server;
a second converter that converts the retrieved operation histories to image data for displaying an operation history list of the retrieved operation histories in the order determined by said sorting device; and
a device that produces data for displaying user interface elements on the operation history list in correspondence with the respective operation histories, said user interface element having a function to enter the same sequence of operational information as recorded in the corresponding operation history, wherein
said data for displaying user interface elements on said web image is transmitted along with said data for displaying said web image from said intervening server to said authenticated mobile terminal, to allow said display device to display said web image with said user interface elements superimposed thereon, enabling entering operational information through said user interface on said web image; and
said data for displaying user interface elements on the operation history list is transmitted along with said data for displaying the operation history list from said intervening server to said authenticated mobile terminal, to allow said display device to display the operation history list with said user interface elements superimposed thereon, enabling entering the same sequence of operational information as recorded in the corresponding operation history through said user interface element.

2. A web browsing system as recited in claim 1, wherein said retrieving device retrieves those operation histories which are associated with both the same terminal information and operation information as received from said authenticated mobile terminal from said history storage device.

3. A web browsing system as recited in claim 1, wherein
multiple mobile terminals are connectable to said intervening server; and
said history storage device stores the operation histories in groups sorted according to the associated terminal information.

4. A web browsing system as recited in claim 1, wherein said intervening server counts how many times the same operational information has been received from the same mobile terminal;
said history storage device also records the count as frequency information in each operation history; and
said sorting device sorts the retrieved operation histories according to the frequency information as the communicative conditions between said mobile terminal and said intervening server.

5. A web browsing system as recited in claim 1, wherein
said mobile terminal comprises a device for obtaining information about a present position of said mobile terminal, and transmits the information about the present location to said intervening server;
said history storage device also records the information about the present location in each operation history; and
said sorting device sorts the retrieved operation histories according to the present location as the communicative conditions between said mobile terminal and said intervening server.

6. A web browsing system as recited in claim 1, wherein
said history storage device also records in each operation history the time of entry of each operational information; and
said sorting device sorts the retrieved operation histories according to the time of entry as the communicative conditions between said mobile terminal and said intervening server.

7. A web browsing system as recited in claim 1, wherein one of said user interface elements displayed on said operation history list is selectable by operating said input device, to transmit a sequence of operational information corresponding to the selected user interface from said mobile terminal to said intervening server.

8. A web browsing system as recited in claim 1, wherein
multiple mobile terminals are connectable to said intervening server;
said intervening server sorts the multiple mobile terminals into groups according to their terminal information; and
said retrieving device also retrieves from said history storage device those operation histories which are associated with the terminal information of those mobile terminals which belong to the same group as said authenticated mobile terminal.

9. A web browsing system as recited in claim 1, wherein said second converter produces brief operation history from each of the retrieved operation histories and converts the brief operation histories to image data for displaying the operation history list.

10. A control method for a web browsing system comprising a mobile terminal and an intervening server connectable to each other over a network, wherein said mobile terminal comprising an input device operated to input operational information and a display device for displaying images including various information, said control method comprising the steps of:
authenticating the user of said mobile terminal by said intervening server on the basis of terminal information about said mobile terminal when said intervening server receives said terminal information from said mobile terminal;
capturing a web page from a web server to said intervening server in accordance with operational information from said mobile terminal when said mobile terminal is authenticated;
converting, in said intervening server, said web page to image data for displaying a web image corresponding to said web page on said display device of said mobile terminal;
producing, in said intervening server, data for displaying user interface elements on said web image, said user interface elements having the same function as user interface elements provided on said web page;
transmitting said data for displaying user interface elements on said web image along with said data for displaying said web image from said intervening server to said authenticated mobile terminal, to allow said display device to display said web image with said user interface elements superimposed thereon on, enabling entering operational information through said user interface on said web image;
storing operation histories in said intervening server, each operation history recording a sequence of operational information received from an authenticated mobile terminal in association with terminal information about said authenticated mobile terminal;
retrieving, each time said mobile terminal is authenticated in said authenticating step, those operation histories which are stored in association with the terminal information of said authenticated mobile terminal;
sorting, in said intervening server, the retrieved operation histories in the order determined based on communicative conditions between said mobile terminal and said intervening server;
converting, in said intervening server, the retrieved operation histories to image data for displaying an operation history list of the retrieved operation histories in the order determined by said sorting step;
producing, in said intervening server, data for displaying user interface elements on the operation history list in correspondence with the respective operation histories, said user interface element having a function to enter the same sequence of operational information as recorded in the corresponding operation history; and
transmitting said data for displaying user interface elements on the operation history list along with said data for displaying the operation history list from said intervening server to said authenticated mobile terminal, to allow said display device to display the operation history list with said user interface elements superimposed thereon, enabling entering the same sequence of operational information as recorded in the corresponding operation history through said user interface element.

11. An intervening server that intervenes between mobile terminals and a web server over a network, said intervening server comprising:
an authenticating device that authenticates the user of a mobile terminal on the basis of terminal information about said mobile terminal when said terminal information is received from said mobile terminal;
a web page capturing device that captures a web page from said web server in accordance with operational information from said mobile terminal when said mobile terminal is authenticated by said authenticating device;
a converter that converts said web page to image data for displaying a web image corresponding to said web page on a display device of said mobile terminal;
a device that produces data for displaying user interface elements on said web image, said user interface elements having the same function as user interface elements provided on said web page;
a history storage device that stores operation histories each recording a sequence of operational information received from an authenticated mobile terminal in association with terminal information about said authenticated mobile terminal;
a retrieving device that retrieves, each time said mobile terminal is authenticated, those operation histories which are stored in association with the terminal information of said authenticated mobile terminal from said history storage device;
a sorting device that sorts the retrieved operation histories in the order determined based on communicative conditions between said mobile terminal and said intervening server;
a second converter that converts the retrieved operation histories to image data for displaying an operation history list of the retrieved operation histories in the order determined by said sorting device;
a device that produces data for displaying user interface elements on the operation history list in correspondence with the respective operation histories, said user interface element having a function to enter the same sequence of operational information as recorded in the corresponding operation history;
a device for transmitting said data for displaying user interface elements on said web image to said authenticated mobile terminal along with said data for displaying said web image, to allow said display device to display said web image with said user interface elements superimposed thereon, enabling entering operational information through said user interface on said web image; and
a device for transmitting said data for displaying user interface elements on the operation history list to said authenticated mobile terminal along with said data for displaying the operation history list from said intervening server, to allow said display device to display the operation history list with said user interface elements superimposed thereon, enabling entering the same sequence of operational information as recorded in the corresponding operation history through said user interface element.
